(19) United States
(12) Patent Application Publication
(10) Pub. No.: US 2026/0034904 A1
(43) Pub. Date: Feb. 5, 2026

(54) VEHICLE AND METHOD FOR ITS OPERATION

(71) Applicant: MERCEDES-BENZ GROUP AG, Stuttgart (DE)

(72) Inventors: Markus ORNER, Rennigen (DE); Nathan TROESTER, Stuttgart (DE); Urs BOEHME, Ehningen (DE); Jörg WEIGOLD, Stuttgart (DE)

(21) Appl. No.: 18/996,164

(22) PCT Filed: Jul. 14, 2023
(86) PCT No.: PCT/EP2023/069731

§ 371 Date: Jan. 17, 2025

(30) Foreign Application Priority Data
Jul. 18, 2022 (DE) 10 2022 002 606.6

(51) Int. Cl. B60L 53/24; B60L 53/10

(52) U.S. Cl. CPC B60L 53/24; B60L 53/11; B60L 2210/14; B60L 2210/42; B60L 2240/526

(57) ABSTRACT

A vehicle includes a traction battery, a drive unit having a three-phase motor and an inverter electrically coupled to the three-phase motor, the inverter being electrically coupled to the traction battery, and a charging connection for electrically coupling to a vehicle-external DC charging station. The inverter is a flying capacitor inverter.

### BACKGROUND AND SUMMARY OF THE INVENTION

Exemplary embodiments of the invention relate to a vehicle and a method for its operation.

A charging system having multiple inputs and a method using a motor drive system is known from the prior art, as described in DE 10 2019 217 666 A1 and US 2020/0361323 A1. A multiple-input charging system using the motor drive system comprises an inverter connected to a battery that is chargeable. The inverter comprises a plurality of switching elements. The multiple-input charging system further comprises a motor connected to the inverter and set up to provide current to the inverter, which is provided to a neutral point of the motor, a first relay, the end of which is connected to the battery and the opposite end of which is connected to a charging capacity input connection to which DC charging capacity is externally applied, a second relay, the end of which is connected to the neutral point and the opposite end of which is connected to the charging capacity input connection, a neutral point capacitor connected to the opposite end of the first relay and the opposite end of the second relay and set up to form an input charging voltage, a third relay, the end of which is connected to the neutral point capacitor and the opposite end of which is connected to the charging capacity input connection, and a control set up to switch on the third relay in a charging mode for charging the battery, to selectively switch on the first relay and the second relay based on the magnitude of the DC charging voltage to supply the DC charging capacity to the battery, and to control the plurality of switching elements of the inverter to forcibly discharge the neutral point capacitor when the charging of the battery is completed.

A bridge circuit and a charge pump are described in DE 10 2019 116 769 A1. The bridge circuit comprises a first capacitor, a second capacitor, a first switch, a second switch, a first diode, and a second diode. The first capacitor and the second capacitor are connected in series and form a supply circuit. A first half-bridge circuit is connected in parallel to the supply circuit, which half-bridge circuit has the first switch, the second switch, the first diode, the second diode, and a first resonant main circuit. The first switch and the second switch are connected in series at a first bridge point and arranged parallel to the first capacitor. The first diode and the second diode are connected in series at a second bridge point and arranged parallel to the second capacitor. The first resonant main circuit is connected to the first bridge point and the second bridge point. A discharge circuit is connected to the first resonant main circuit at the second bridge point. The discharge circuit is constructed as a second half-bridge circuit and is set up such that it maintains a current flow in the bridge point when switching the first and/or the second switch when substantially no current is flowing in the first resonant main circuit.

An electric drive system for a vehicle and a method for operating a corresponding electric drive system are known from DE 10 2021 003 852 A1. The electric drive system comprises an electric three-phase motor for driving the vehicle, an electrical energy storage device for supplying the electric three-phase motor with electricity while the vehicle is in driving operation, an inverter of the electric three-phase motor, which is electrically coupled to the electrical energy storage device, and a charging connection on the vehicle side for electrically coupling the electrical energy storage device to a charging unit external to the vehicle. Depending on the inverter, a charging voltage of the vehicle-side charging connection can be converted into a supply voltage for charging the electrical energy storage device.

An electric drive system for a vehicle, a vehicle having a corresponding electric drive system, and a method for operating a corresponding electric drive system are described in DE 10 2021 003 883. The electric drive system has a switching device. The switching device comprises a first switching state, in which a charging connection is directly connected to an electrical energy storage device of the vehicle, such that the electrical energy storage device can be charged with an input voltage applied to the charging connection, and a second and third switching state, in which the charging connection is connected to the electrical energy storage device via an inverter, such that the electrical energy storage device can be charged depending on the inverter.

Exemplary embodiments of the invention are directed to a vehicle which is improved in relation to the prior art, and a method for its operation which is improved in relation to the prior art.

A vehicle comprises a traction battery, a drive unit having a three-phase motor, and an inverter electrically coupled to the three-phase motor, wherein the inverter is electrically coupled to the traction battery, and a charging connection for electric coupling to a vehicle-external DC charging station.

The traction battery is in particular a high-voltage battery. The term “high-voltage”, also abbreviated to HV, is to be understood in particular as an electric DC voltage which is in particular higher than approximately 60V. The term “high-voltage” is in particular to be interpreted as conforming to the ECE R 100 standard. The traction battery serves in particular for supplying electrical energy to the drive unit to drive the vehicle.

In accordance with the invention, the inverter is designed as a flying capacitor inverter, in particular as a three-phase, three-level inverter with flying capacitors.

In a method according to the invention for operating the vehicle, the charging voltage is converted by means of the inverter into a voltage with a voltage value corresponding at least to the nominal voltage of the traction battery in order to charge the traction battery by means of a DC charging station electrically coupled to the charging connection and whose charging voltage is lower than a nominal voltage of the traction battery.

In particular, it is also provided that, when the vehicle is in driving operation, a DC voltage provided by the traction battery is converted by means of the inverter into an alternating voltage for supplying electrical energy to the three-phase motor.

In the solution according to the invention, components already present in the vehicle, in particular the inverter, which is already provided for converting the DC voltage of the traction battery into an alternating voltage for the three-phase motor in the vehicle, are thus advantageously additionally used to charge the traction battery with a DC voltage provided by a DC charging station, which is lower than the nominal voltage of the traction battery. Only filters and contactors, for example, are required as additional components.

In order to enable this, it is provided, in particular, that the inverter has three parallel strings, each also referred to as a phase, between a positive potential line and a negative potential line, each with four semiconductor switching units connected electrically in series, wherein an inverter capacitor is arranged between a tap between the first semiconductor switching unit and the second semiconductor switching unit, and a tap between the third semiconductor switching unit and the fourth semiconductor switching unit of the respective string. In particular, the semiconductor switching units each have a semiconductor switch and a diode. In particular, the semiconductor switches are each designed as a bipolar transistor having an insulated gate electrode.

It is in particular provided that center taps of the strings are each electrically coupled to a motor winding of the three-phase motor.

It is in particular provided that one potential connection of the charging connection is electrically coupled to a neutral point of the three-phase motor and the other potential connection of the charging connection is electrically coupled to the same potential of the traction battery via the potential line of the inverter having the same potential. The term “same potential” is to be understood in particular as the same sign of the potential, i.e., the same potential is either the positive potential or the negative potential.

In a possible embodiment, it is provided that an electrical series connection of two output capacitors is provided on a traction battery side of the inverter between the two potential lines, wherein the potential connection of the charging connection, which is electrically coupled to the neutral point of the three-phase motor, is also electrically coupled to a center tap between these two output capacitors. It is alternatively provided, for example, that only one output capacitor is arranged on the traction battery side of the inverter between the two potential lines.

It is in particular provided that the charging connection is electrically coupled to an input capacitor.

In the method for operating the vehicle, it is in particular provided that, for charging the traction battery by means of a DC charging station electrically coupled to the charging connection and whose charging voltage is lower than the nominal voltage of the traction battery, in a first step the semiconductor switch closest to the potential line of the inverter, which is electrically coupled to the charging connection, is closed in one of the strings of the inverter and the subsequent semiconductor switch remains open, and in a second step the semiconductor switch closest to the potential line of the inverter, which is electrically coupled to the charging connection, is opened and then the subsequent semiconductor switch is closed.

In this solution, the interaction of the motor inductance of the three-phase motor with the inverter capacitor of the flying capacitor bridge of the inverter forms a resonant circuit. This allows losses in the semiconductors to be minimized or inexpensive semiconductors to be used. Furthermore, EMC filters (EMC=electromagnetic compatibility) can be favorably kept, as the harmonic content of interference is very low.

By means of the solution according to the invention, the traction battery can therefore also be charged at a DC charging station whose charging voltage is lower than the nominal voltage of the traction battery with no or only a little additional effort. By way of example, the nominal voltage of the traction battery is 800V and the charging voltage is 400V. As described, the flying capacitor inverter is used as the inverter topology for this, wherein, in order to enable to this charging of the traction battery, i.e., in order to raise the low charging voltage to the level of the nominal voltage of the traction battery, a potential connection of the charging connection and thus a pole of the DC charging station electrically coupled to the charging connection is connected to the neutral point of the three-phase motor, and the other potential connection of the charging connection and thus the other pole of the DC charging station electrically coupled to the charging connection is connected to the pole of the traction battery having the same potential. The resulting interconnection makes it possible to function as a resonant charge pump.

Exemplary embodiments of the invention are explained in more detail below with reference to the drawings.

### BRIEF DESCRIPTION OF THE DRAWING FIGURES

Here are shown:

FIG. 1 schematically, an embodiment of a vehicle coupled to a DC charging station,

FIG. 2 schematically, a first step of a mode of operation of the embodiment according to FIG. 1,

FIG. 3 schematically, a second step of the mode of operation of the embodiment according to FIG. 1,

FIG. 4 schematically, a mode of operation of a detail of the embodiment according to FIG. 1,

FIG. 5 schematically, a modification of the embodiment according to FIG. 1,

FIG. 6 schematically, a first step of a mode of operation of a further embodiment of a vehicle coupled to a DC charging station,

FIG. 7 schematically, a second step of the mode of operation of the further embodiment,

FIG. 8 schematically, a mode of operation of a detail of the further embodiment, and

FIG. 9 schematically, a modification of the further embodiment.

Parts corresponding to one another are provided with the same reference numerals in all figures.

### DETAILED DESCRIPTION

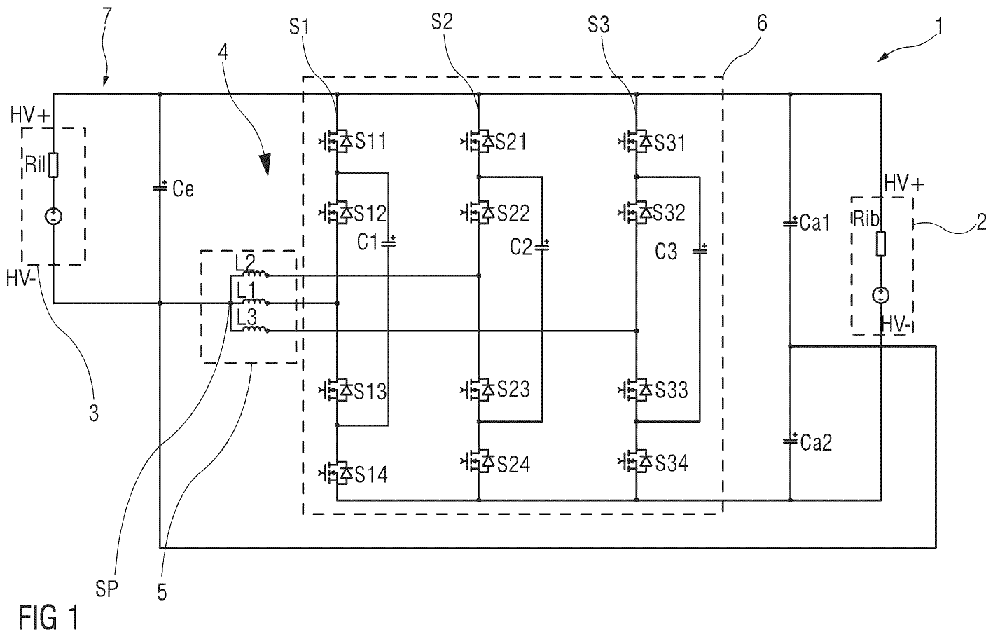

FIGS. 1 to 9 show a vehicle 1 and its mode of operation during charging of a traction battery 2 of the vehicle 1 at a vehicle-external DC charging station 3, the charging voltage of which is lower than a nominal voltage of the traction battery 2. In FIGS. 1 to 9, the vehicle 1 is already electrically coupled to the DC charging station 3 in each case. An internal resistance Ril of the DC charging station 3 and an internal resistance Rib of the traction battery 2 are also respectively depicted in FIGS. 1 to 9.

The vehicle 1 comprises the traction battery 2, a drive unit 4 having a three-phase motor 5 and an inverter 6 electrically coupled to the three-phase motor 5, wherein the inverter 6 is electrically coupled to the traction battery 2, and a charging connection 7 for electrical coupling to the vehicle-external DC charging station 3.

The inverter 6 is designed as a flying capacitor inverter, in particular as a three-phase, three-level inverter with flying capacitors.

The inverter 6 has three parallel strings S1, S2, S3, each having four semiconductor switching units S11 to S34 electrically connected in series, between a positive potential line and a negative potential line, wherein in each case, an inverter capacitor C1, C2, C3 is arranged between a tap between the first semiconductor switching unit S11, S21, S31 and the second semiconductor switching unit S12, S22, S32, and a tap between the third semiconductor switching unit S13, S23, S33 and the fourth semiconductor switching unit S14, S24, S34 of the respective string S1, S2, S3. The semiconductor switching units S11 to S34 each have, in particular, a semiconductor switch and a diode, in particular a body diode.

Center taps of the strings S1, S2, S3 are each electrically coupled to a motor winding L1, L2, L3 of the three-phase motor 5.

A potential connection of the charging connection 7 and thus the pole of the DC charging station 3 connected to this potential connection is electrically coupled to a neutral point SP of the three-phase motor 5. The other potential connection of the charging connection 7 and thus the other pole of the DC charging station 3 connected to this potential connection is electrically coupled to the same potential HV+, HV− of the traction battery 2 via the potential line of the inverter 6 which has the same potential HV+, HV−.

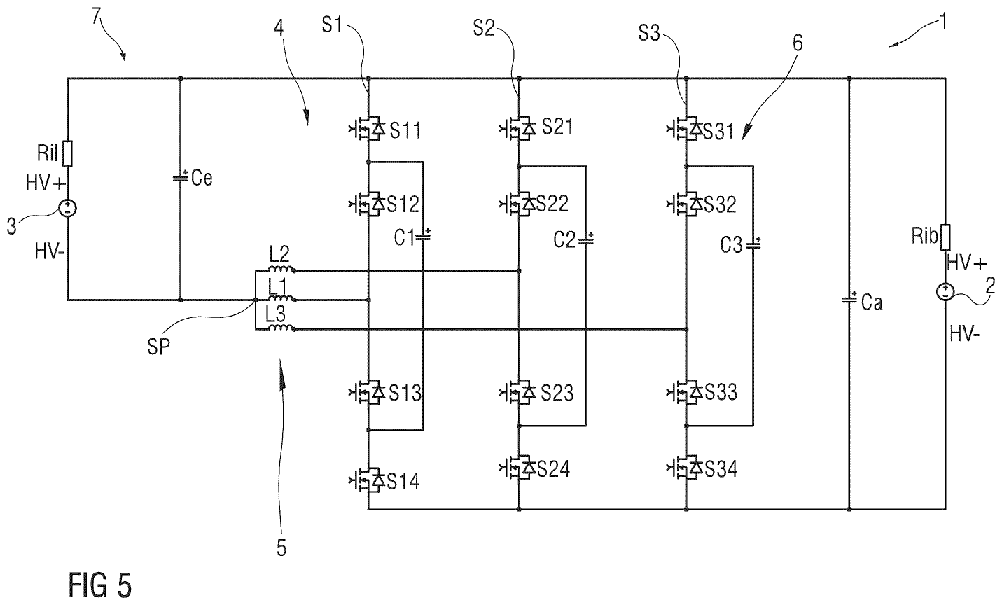

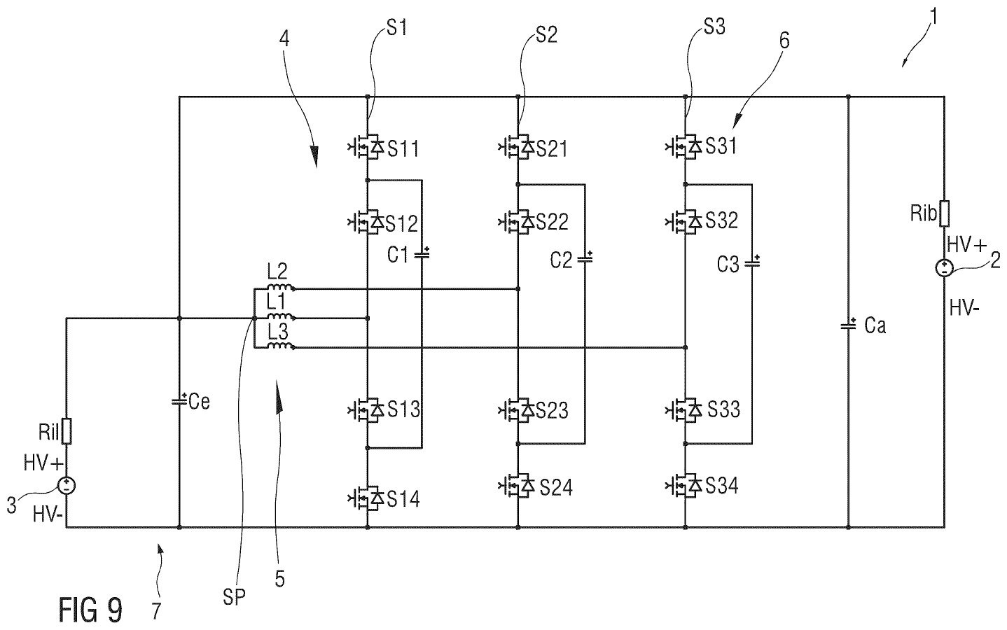

As shown in FIGS. 1 to 4 and 6 to 8, it can additionally be provided that an electrical series connection of two output capacitors Ca1, Ca2 is arranged on a traction battery side of the inverter 6 between the two potential lines, wherein the potential connection of the charging connection 7, which is electrically coupled to the neutral point SP of the three-phase motor 5, is additionally electrically coupled to a center tap between these two output capacitors Ca1, Ca2. Alternatively, as shown in FIGS. 5 and 9, it can be provided that only one output capacitor Ca is arranged on the traction battery side of the inverter 6 between the two potential lines.

Furthermore, it is provided that the charging connection 7 is electrically coupled to an input capacitor Ce, i.e., the potential connections of the charging connection 7 are each electrically coupled to a connection of the input capacitor Ce.

The interconnection described and depicted in FIGS. 1 to 9 offers the possibility of operating as a resonant charge pump and thus raising the charging voltage of the DC charging station 3 to the level of the nominal voltage of the traction battery 2. The resonant circuit is formed by the motor inductance, i.e., by the motor winding L1, L2 or L3, and the inverter capacitor C1, C2 or C3 of the flying capacitor bridge.

The embodiments shown in FIGS. 1 to 4 and 6 to 8, in which the electrical series connection of the two output capacitors Ca1, Ca2 is arranged on the traction battery side of the inverter 6 between the two potential lines, wherein the potential connection of the charging connection 7, which is electrically coupled to the neutral point SP of the three-phase motor 5, is also electrically coupled to the center tap between these two output capacitors Ca1, Ca2, also offers the possibility of exploiting advantages in power transmission and EMC.

In a method for operating the vehicle 1, it is in particular provided that, for charging the traction battery 2 by means of a DC charging station 3 electrically coupled to the charging connection 7 and whose charging voltage is lower than the nominal voltage of the traction battery 2, in a first step the semiconductor switch S11, S21, S31, S14, S24, S34 closest to the potential line of the inverter 6, which is electrically coupled to the charging connection 7, is closed in one of the strings S1, S2, S3 of the inverter 6 and the subsequent semiconductor switch S12, S22, S32, S13, S23, S33 remains open, and in a second step the semiconductor switch S11, S21, S31, S14, S24, S34 closest to the potential line of the inverter 6, which is electrically coupled to the charging connection 7, is opened and then the subsequent semiconductor switch S12, S22, S32, S13, S23, S33 is closed.

The solution is described in detail again below with reference to FIGS. 1 to 9.

In the embodiment according to FIGS. 1 to 5, the negative potential connection of the charging connection 7 and thus the negative pole of the DC charging station 3 connected to this negative potential connection is electrically coupled to the neutral point SP of the three-phase motor 5. The positive potential connection of the charging connection 7 and thus the positive pole of the DC charging station 3 connected to this positive potential connection is electrically coupled to the positive potential HV+ of the traction battery 2 via the potential line of the inverter 6 which has the positive potential HV+. In this embodiment, the negative potential HV− of the DC charging station 3 is thus further reduced, while the positive potential HV+ between the DC charging station 3 and the traction battery 2 remains at the same level.

In the embodiment according to FIGS. 1 to 4, the negative potential connection of the charging connection 7, which is electrically coupled to the neutral point SP of the three-phase motor 5, is additionally electrically coupled to the center tap between the two output capacitors Ca1, Ca2.

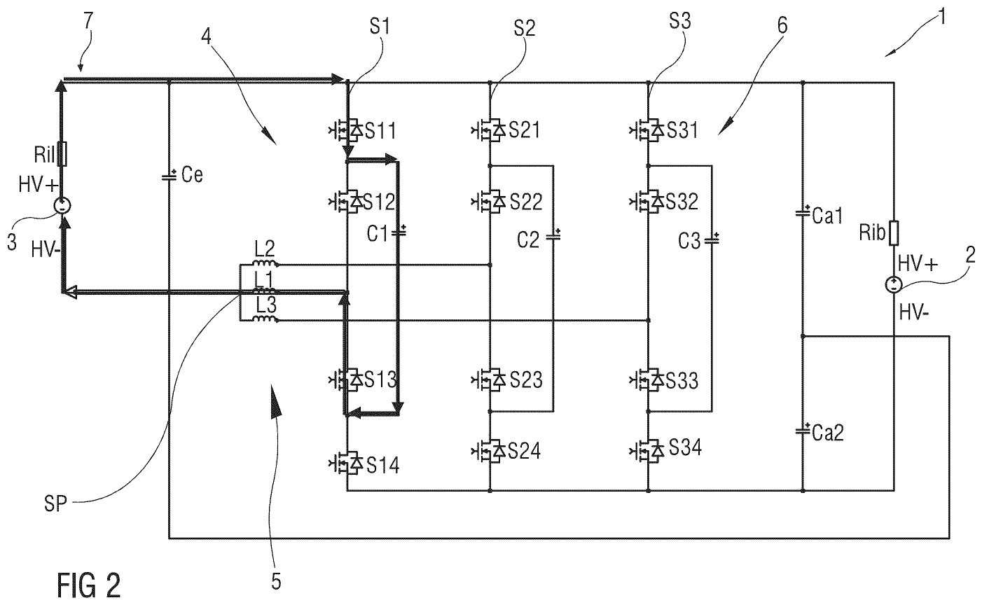

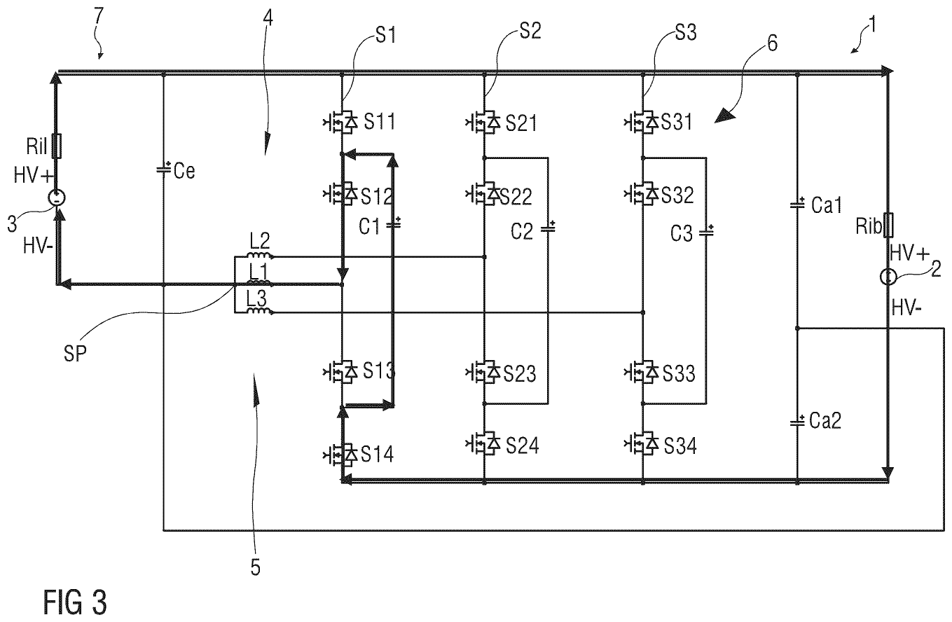

FIGS. 2 and 3 show the mode of operation of this embodiment.

In the first step shown in FIG. 2, the first semiconductor switching unit S11 of the first string S1 is closed and the second semiconductor switching unit S12 of the first string S1 remains open. The charging voltage of the DC charging station 3 is applied to the series connection of the first inverter capacitor C1 and the first motor winding L1. The first motor winding L1 and the first inverter capacitor C1 form a resonant circuit. The current builds up and decreases again with a sine half-oscillation. The first inverter capacitor C1 is charged in the process.

In the second step shown in FIG. 3, the first semiconductor switching unit S11 of the first string S1 is opened and then the second semiconductor switching unit S12 of the first string S1 is closed. The voltage of the first inverter capacitor C1 is now connected in series to the charging voltage of the DC charging station 3 and is added together. The current builds up and decreases again with a sine half-oscillation. The first inverter capacitor C1 is discharged in the process. The current direction in the first motor winding L1 remains identical to the first step. The circuit now runs from the DC charging station 3 via the traction battery 2, the fourth semiconductor switching unit S14 of the first string S1, in particular its body diode, the first inverter capacitor C1, the second semiconductor switching unit S12 of the first string S1 and the first motor winding L1. The traction battery 2 is thus charged.

The third and fourth semiconductor switching units S13, S14 of the first string S1 only act as a diode, in particular a body diode, in the entire process.

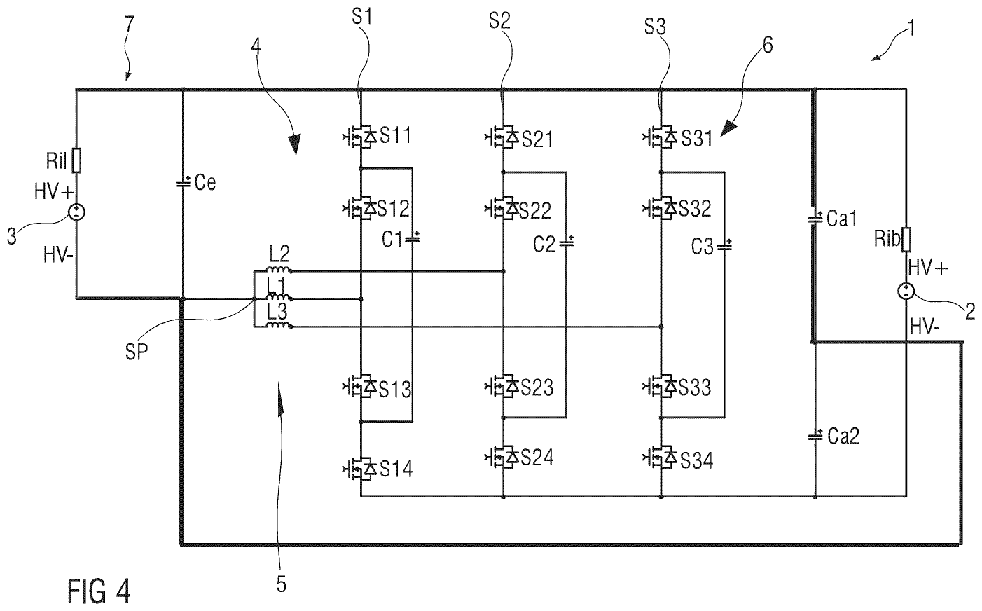

FIG. 4 shows the mode of operation of the embodiment according to FIGS. 1 to 3, if the negative potential connection of the charging connection 7, which is electrically coupled to the neutral point SP of the three-phase motor 5, is also electrically coupled to the center tap between the two output capacitors Ca1, Ca2. As a result, the first output capacitor Ca1 is always parallel to the DC charging station 3 and the input capacitor Ce. With its voltage increase, the charge pump generates an increase in the series connection of the two output capacitors Ca1, Ca2, i.e., because the first output capacitor Ca1 is constantly at the level of the charging voltage of the DC charging station 3, only the second output capacitor Ca2 is charged.

FIG. 5 shows the embodiment according to FIGS. 1 to 3, in which, however, only one output capacitor Ca is present, and thus the negative potential connection of the charging connection 7, which is electrically coupled to the neutral point SP of the three-phase motor 5, is not additionally electrically coupled to the center tap between the two output capacitors Ca1, Ca2. Nevertheless, the circuit is still fundamentally functional in order to enable the traction battery 2 to be charged at the DC charging station 3, the charging voltage of which is lower than the nominal voltage of the traction battery 2.

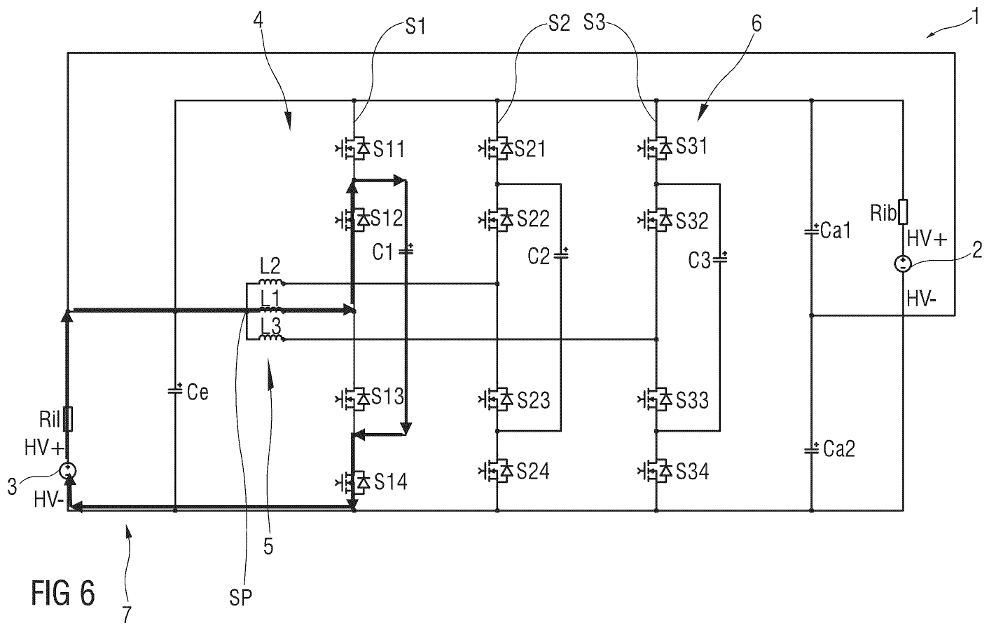

In the embodiment according to FIGS. 6 to 9, the positive potential connection of the charging connection 7 and thus the positive pole of the DC charging station 3 connected to this positive potential connection is electrically coupled to the neutral point SP of the three-phase motor 5. The negative potential connection of the charging connection 7 and thus the negative pole of the DC charging station 3 connected to this negative potential connection is electrically coupled to the negative potential HV− of the traction battery 2 via the potential line of the inverter 6 having the negative potential HV−. In this embodiment, the positive potential HV+ of the DC charging station 3 is thus further reduced, while the negative potential HV− between the DC charging station 3 and the traction battery 2 remains at the same level.

In the embodiment according to FIGS. 6 to 8, the positive potential connection of the charging connection 7, which is electrically coupled to the neutral point SP of the three-phase motor 5, is additionally electrically coupled to the center tap between the two output capacitors Ca1, Ca2.

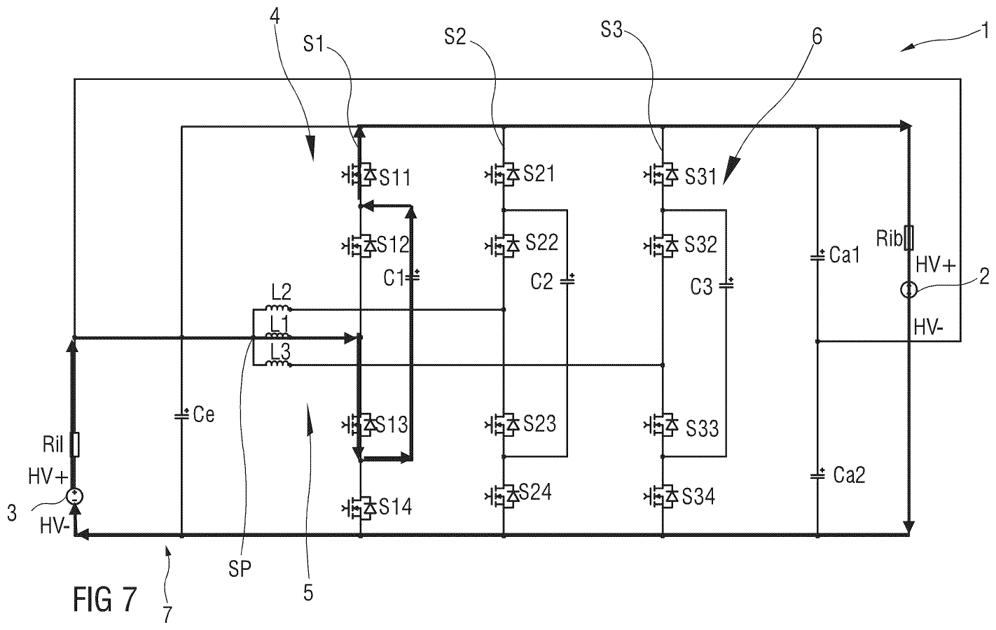

FIGS. 6 and 7 show the mode of operation of this embodiment.

In the first step shown in FIG. 6, the fourth semiconductor switching unit S14 of the first string S1 is closed and the third semiconductor switching unit S13 of the first string S1 remains open. The charging voltage of the DC charging station 3 is applied to the series connection of the first inverter capacitor C1 and the first motor winding L1. The first motor winding L1 and the first inverter capacitor C1 form a resonant circuit. The current builds up and decreases again with a sine half-oscillation. The first inverter capacitor C1 is charged in the process.

In the second step shown in FIG. 7, the fourth semiconductor switching unit S14 of the first string S1 is opened and then the third semiconductor switching unit S13 of the first string S1 is closed. The voltage of the first inverter capacitor C1 is now connected in series to the charging voltage of the DC charging station 3 and is added together. The current builds up and decreases again with a sine half-oscillation. The first inverter capacitor C1 is discharged in the process. The current direction in the first motor winding L1 remains identical to the first step. The circuit now runs from the DC charging station 3 via the first motor winding L1, the third semiconductor switching unit S13 of the first string S1, the first inverter capacitor C1, the second semiconductor switching unit S12 of the first string S1, in particular its body diode, the traction battery 2 and back. The traction battery 2 is thus charged.

The first and second semiconductor switching unit S11, S12 of the first string S1 only act as a diode, in particular a body diode, in the entire process.

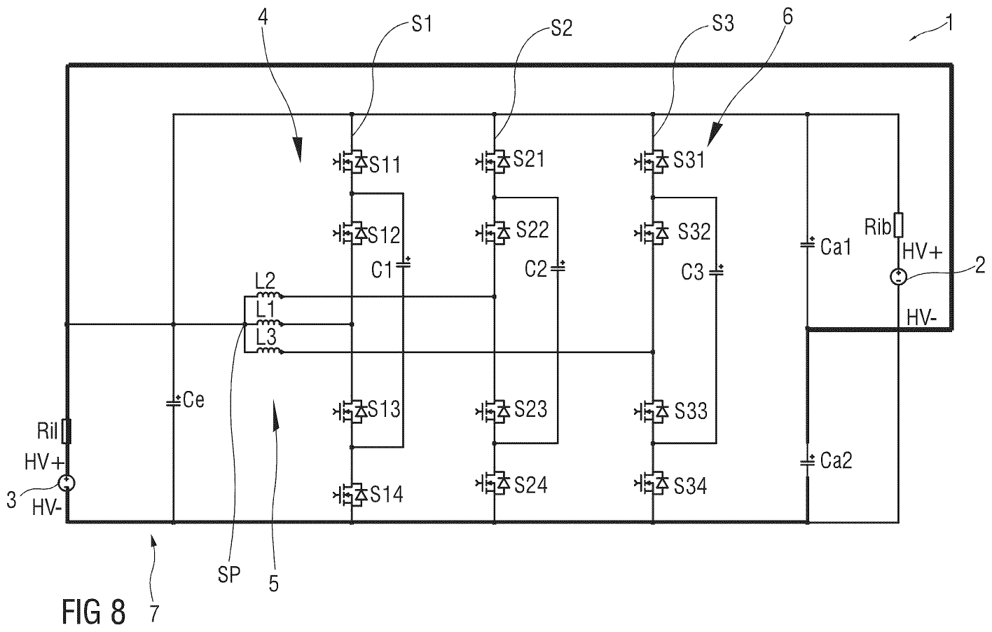

FIG. 8 shows the mode of operation of the embodiment according to FIGS. 6 and 7, if the positive potential connection of the charging connection 7, which is electrically coupled to the neutral point SP of the three-phase motor 5, is also electrically coupled to the center tap between the two output capacitors Ca1, Ca2. As a result, the second output capacitor Ca2 is always parallel to the DC charging station 3 and the input capacitor Ce. With its voltage increase, the charge pump generates an increase in the series connection of the two output capacitors Ca1, Ca2, i.e., because the second output capacitor Ca2 is constantly at the level of the charging voltage of the DC charging station 3, only the first output capacitor Ca1 is charged.

FIG. 9 shows the embodiment according to FIGS. 6 and 7, in which, however, only one output capacitor Ca is present, and thus the positive potential connection of the charging connection 7, which is electrically coupled to the neutral point SP of the three-phase motor 5, is not additionally electrically coupled to the center tap between the two output capacitors Ca1, Ca2. Nevertheless, the circuit is still fundamentally functional in order to enable the traction battery 2 to be charged at the DC charging station 3, the charging voltage of which is lower than the nominal voltage of the traction battery 2.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### REFERENCE NUMERAL LIST

1 vehicle
2 traction battery
3 DC charging station
4 drive unit
5 three-phase motor
6 inverter
7 charging connection
C1, C2, C3 inverter capacitor
Ca, Ca1, Ca2 output capacitor
Ce input capacitor
HV+, HV− potential
L1, L2, L3 motor winding
Rib internal resistance of the traction battery
Ril internal resistance of the DC charging station
S1, S2, S3 string
S11 bis S34 semiconductor switching units
SP neutral point

1-5. (canceled)

6. A vehicle comprising:
a traction battery;
a drive unit having a three-phase motor and an inverter electrically coupled to the three-phase motor, wherein the inverter is electrically coupled to the traction battery, and wherein the inverter is a flying capacitor inverter; and
a charging connection electrically coupled to an input capacitor and configured to electrically couple to a vehicle-external DC charging station,
wherein a first potential connection of the charging connection is electrically coupled to a neutral point of the three-phase motor and a second potential connection of the charging connection is electrically coupled to a same potential of the traction battery via a potential line of the inverter having a same potential, and
wherein an electrical series connection of two output capacitors is arranged on a traction battery side of the inverter between the first and second potential lines, wherein a potential connection of the charging connection, which is electrically coupled to the neutral point of the three-phase motor, is additionally electrically coupled to a center tap between the two output capacitors.

7. A method for operating a vehicle comprising a traction battery; a drive unit having a three-phase motor and an inverter electrically coupled to the three-phase motor, wherein the inverter is electrically coupled to the traction battery, and wherein the inverter is a flying capacitor inverter; and a charging connection electrically coupled to an input capacitor and configured to electrically couple to a vehicle-external DC charging station, wherein a first potential connection of the charging connection is electrically coupled to a neutral point of the three-phase motor and a second potential connection of the charging connection is electrically coupled to a same potential of the traction battery via a potential line of the inverter having a same potential, and wherein an electrical series connection of two output capacitors is arranged on a traction battery side of the inverter between as, wherein a potential connection of the charging connection, which is electrically coupled to the neutral point of the three-phase motor, is additionally electrically coupled to a center tap between the two output capacitors, the method comprising:
for charging the traction battery by the vehicle-external DC charging station electrically coupled to the charging connection having a charging voltage lower than a nominal voltage of the traction battery, the charging voltage is converted by the inverter into a voltage with a voltage value corresponding at least to the nominal voltage of the traction battery.

8. The method of claim 7, wherein the inverter includes a plurality of strings, and wherein, in one of the strings of the inverter
in a first step, a semiconductor switch closest to the potential line of the inverter, which is electrically coupled to the charging connection, is closed and a subsequent semiconductor switch remains open, and
in a second step, the semiconductor switch closest to the potential line of the inverter, which is electrically coupled to the charging connection, is opened and then the subsequent semiconductor switch is closed.

9. The method of claim 7, wherein, when the vehicle is in driving operation, a DC voltage provided by the traction battery is converted by the inverter into an alternating voltage to supply electrical energy to the three-phase motor.
